(19) United States
(12) Patent Application Publication
(10) Pub. No.: US 2026/0072141 A1
(43) Pub. Date: Mar. 12, 2026

(54) MICROMECHANICAL OPTICAL-SENSOR STRUCTURE

(71) Applicant: COMMISSARIAT À L'ENERGIE ATOMIQUE ET AUX ENERGIES ALTERNATIVES, PARIS (FR)

(72) Inventors: Sylvain GUERBER, GRENOBLE (FR); Daivid FOWLER, GRENOBLE (FR)

(21) Appl. No.: 19/313,572

(22) Filed: Aug. 28, 2025

(30) Foreign Application Priority Data
Sep. 6, 2024 (FR) 2409462

(51) Int. Cl. G01S 7/481; G01S 17/931

(52) U.S. Cl. CPC G01S 7/4817; G01S 17/931

(57) ABSTRACT

A micromechanical optical-sensor structure includes a microbeam that is able to bend about a first direction, an actuator controlled to modify the orientation of the microbeam about the direction and, at a free end of the microbeam, antennas of an optical phased array, the antennas being arranged to emit a light beam that is orientable about a second direction transverse to the first direction. The micromechanical structure in addition includes an on-board sensor in the microbeam transmitting a signal representative of the current orientation of the microbeam about the first direction.

### CROSS-REFERENCE TO RELATED APPLICATION

This application claims priority to foreign French patent application No. FR 2409462, filed on Sep. 6, 2024, the disclosure of which is incorporated by reference in its entirety.

### FIELD OF THE INVENTION

The invention relates to the field of integrated optics, with applications in the field of lidar systems (lidar being the acronym of light detection and ranging). It uses the technology of OPA circuits (OPA standing for optical phased array), possibly on-chip. It will for example be employed in the automotive sector-specifically, a lidar in a vehicle makes it possible to detect a pedestrian or some other obstacle. Basing production of lidars on integrated photonic devices is likely to greatly decrease the cost of sensors while improving performance.

### BACKGROUND

An OPA is based on a power splitter that distributes the beam emitted by a coherent light source, typically a laser, between a series of optical antennas the emitting ends of which are placed in a straight line or row (1D OPAs are therefore referred to), each optical antenna emitting a fraction of the optical power of the source. These antennas are spaced apart from one another on the straight line by a distance that is often constant and of the order of the wavelength of the transmitted signal—typically a few μm or less. The system also comprises phase modulators (generally in an amount of one per antenna) that allow the phase differences between the optical signals emitted from one antenna to another to be controlled. A linear phase gradient is applied between the signals emitted by each antenna along the straight line, and interference is produced. This takes the form of a beam directed in a given direction. By modifying the slope of the linear phase gradient, it is possible to move the direction of emission to the left or right of the series of antennas and therefore perform a scan.

This type of circuit therefore makes it possible to direct an optical beam in a chosen direction without any moving mechanical parts. This technique is referred to as solid-state beam steering. It is discussed in the article by Doylend et al. Two-dimensional free-space beam steering with an optical phased array on silicon-on-insulator, Opt. Express, 2011, vol. 19, no. 22, p. 21595. Nevertheless, without another beam-steering strategy, it is only possible to orient the beam, and therefore perform a scan, in a single direction (denoted q).

One method for steering the beam in a second direction is to modify the wavelength of the source and take advantage of the fact that the optical antennas are diffraction gratings, this implying that their emission angle θ depends on the wavelength of the light.

This method therefore makes it possible to carry out a 2D scan (φ×θ) of the beam using a 1D OPA. However, to obtain a large scanning angle in θ (typically more than 10°) it is necessary to modify the wavelength of the laser significantly (often by more than 100 nm because a typical sensitivity is Δθ ˜0.1° for Δλ ˜1 nm). However, that is difficult to do because the most available laser sources are unable to provide such wavelength variability, in combination with the other performance metrics required by a lidar system such as, in particular, a high power, a narrow linewidth, and a modulatable frequency.

It has also been suggested to produce 2D OPAs using a matrix array of emitters, in particular the article by Sun et al, Large-scale nanophotonic phased array, Nature, vol. 493, no. 7431, 2013. Such a matrix array makes it possible, through individual control of the phase of each emitter, to direct the emitted beam in two complementary directions ((×0).

However, production of a matrix array of optical emitters highly constrains the circuit and consequently such an architecture leads to low-performance systems, either because the emitted power is low or because scanning amplitude is limited.

Furthermore, an approach based on MEMS technology (MEMS being the acronym of micro-electro-mechanical systems) combined with integrated photonics is known from FR3098606A1, FR3112216A1, FR3112217A1, FR3112218A1 and the article by Guerber S. et al. Active optical phased array integrated within a micro-cantilever, Communications Engineering volume 3, 76, 2024.

As illustrated in FIGS. 1 and 2, which are micrographs, the case in point is a silicon carrier 1 (a wafer) bearing an ordered series of control terminals 4, which for example are 8 in number, a fiber-optic input 5 for the light of a laser and electrical terminals 6 for applying a voltage to a piezoelectric actuator.

A microbeam 10 has been formed in the carrier 1, the microbeam being a component produced in MEMS technology, and being equipped on its upper surface with a-PZT-piezoelectric actuator 11 connected to the electrical terminals 6. The microbeam thus comprises an active element that allows it to be tilted controllably, in the present case a PZT piezoelectric element (PZT standing for lead zirconate titanate). The latter is activated on demand by applying a voltage across the two electrical terminals 6.

The microbeam 10 is also equipped on its upper surface with an optical phased array (OPA). The optical phased array consists of: a splitter 12 that is connected to the optical input 5 and that splits the light between various channels (for example 8 channels each consisting of one waveguide); phase modulators 13—one for each waveguide stemming from the splitter 12; and antennas 14 that form the ends of the waveguides and that emit into free space the waves the phase of which is modulated by the phase modulators 13. The phase modulators 13 are controlled individually via the control terminals 4.

Thus, the presented system comprises a 1D OPA on a microbeam MEMS component that is, as known per se, potentially capable of entering into mechanical resonance and therefore scanning significant angular amplitudes. The scanning directions of the OPA and of the microbeam are orthogonal, so as to allow a 2D scan.

FIG. 1 When no voltage is applied to the terminals of the piezoelectric element 11, the microbeam 10 hangs slightly, because of its weight, the amount it bends being limited by the stiffness of the material. The angle θ assumes a first value, as may be seen in FIG. 1.

FIG. 2 If a voltage of a few volts is applied to the piezoelectric element 11, via the electrical terminals 6, and as may be seen in FIG. 2, the microbeam straightens, this having the effect of modifying the emission angle θ of the beam. By combining this system with an OPA capable of scanning in the direction φ perpendicular to θ, it is possible to scan the emitted beam in two dimensions without modifying the wavelength of the beam.

In addition, by applying a selected sinusoidal signal to the microbeam via the PZT actuator, it is possible to obtain a large variation in the angle θ, of the order of several tens of degrees, due to an effect of resonance of the microbeam.

However, to allow this device to be widely deployed in mass-market applications such as motor vehicles, it would be desirable to be able to track the position of the microbeam in real time, this position being representative of one of the emission angles of the lidar. Such monitoring would guarantee correct operation of the system and the safety of persons-specifically, unintended and undetected immobilization of the microbeam would lead to a concentration of power that could be dangerous to the eyes in particular, and must therefore, if it occurs, be detected for example so as to allow laser emission to be stopped.

Integration of a device for tracking the position of the microbeam in real time is therefore the subject of this invention.

The integration of strain gauges into MEMS microbeams has been addressed in the context of the development of piezoresistive gauges, for example in the document Behrens et al, Piezoresistive cantilever as portable micro force calibration standard J. Micromechanics Microengineering, vol. 13, no. 4, pp. S171-S177, 2003. Such a system composed of a microbeam and of a strain gauge is used to produce sensors of pressure or of gas flow rate or even to measure the deflection of the tip of an atomic force microscope, in the document Dukic et al, Piezoresistive AFM cantilevers surpassing standard optical beam deflection in low noise topography imaging Sci. Rep., vol. 5, no. 1, p. 16393, 2015. These systems do not incorporate an optical phased array.

### SUMMARY OF THE INVENTION

To overcome the difficulties and shortcomings encountered in the prior art, a micromechanical optical-sensor structure is therefore provided that comprises a microbeam that is able to bend about a first direction, an actuator controlled to modify the orientation of the microbeam about said first direction and, at a free end of said microbeam, antennas of an optical phased array, said antennas being arranged to emit a light beam that is orientable about a second direction transverse to the first direction.

The micromechanical structure is noteworthy because it in addition comprises an on-board sensor in the microbeam transmitting a signal representative of a current orientation of the microbeam about the first direction.

The signal may be used by a means for modulating, depending on said signal, a command transmitted to the actuator or a command transmitted to the light source. It is then possible to correct a behavior of the system so as to avoid an accumulation, in a given direction, of too much luminous power.

According to optional and advantageous features:
the microelectronic structure may comprise a means for achieving optical read-out with a view to measuring the signal transmitted by the sensor;
the on-board sensor comprises a waveguide comprising a material the refractive index of which depends on a mechanical stress of said material, which varies with the orientation of the microbeam about said first direction;
the micromechanical structure may comprise a Mach-Zender interferometer, said on-board sensor comprising a sensor arm of said Mach-Zender interferometer;
the microelectronic structure may comprise a beam splitter for transmitting light generated by a given source to the antennas of the optical phased array and to the on-board sensor, which is an optical sensor;
the microelectronic structure may comprise a controlled phase modulator for adapting a phase of a wave, for example a light wave, transmitted to said on-board sensor, and more precisely for modifying an amplitude of an interference signal exploited by said on-board sensor;
the on-board sensor may comprise a waveguide making at least one outward and return trip along the microbeam;
the on-board sensor may comprise a piezoelectric sensor.

The invention also relates to a lidar device comprising a micromechanical optical-sensor structure according to aforementioned principles, and a coherent light source for emitting via the antennas of the optical phased array and a controller for controlling the actuator and the optical phased array so as to orient in two dimensions an emitted lidar beam.

The invention also relates to a motor vehicle comprising such a lidar device for detecting obstacles to the movement of the vehicle.

### BRIEF DESCRIPTION OF THE DRAWINGS

FIG. 1 shows, as already mentioned, a micrograph of a MEMS microbeam equipped with a PZT actuator and an OPA, at rest, according to the prior art.

FIG. 2 shows, again as already mentioned, a similar micrograph of the same object, but with the actuator activated, again according to the prior art.

FIG. 3 shows one embodiment of the invention.

FIG. 4 shows a technical means used in one embodiment of the invention.

FIG. 5 shows a physical principle used in one embodiment.

FIG. 6 shows a second embodiment of the invention.

FIG. 7 shows a top view of the system of FIG. 6.

FIG. 8 shows exploitation of the measurements obtained with the system of FIG. 6.

FIG. 9 shows one variant of the system of FIG. 6.

FIG. 10 shows another variant of the system of FIG. 6.

### DETAILED DESCRIPTION

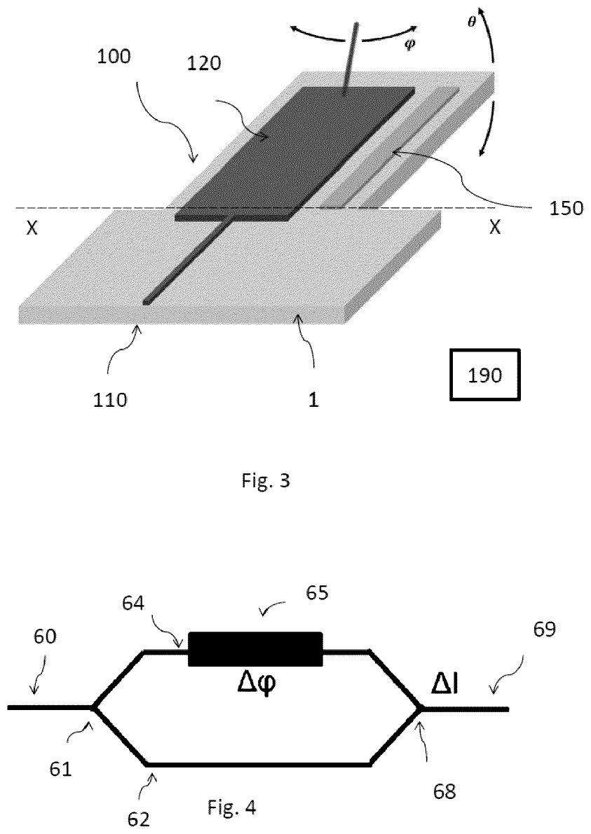

In FIG. 3, a lidar constructed using a planar carrier 1 comprises a microbeam 100 that has been formed in the carrier 1, and that has been equipped with a piezoelectric actuator (not shown) for bending the microbeam about a direction X parallel to the plane of the carrier 1 and perpendicular to the direction of the microbeam. Thus, this bending allows the free end of the microbeam to be oriented at an angle θ.

The microbeam is equipped with an optical input 110 and with an optical phased array (OPA) 120 installed on the microbeam, allowing a scan by an angle φ that, combined with the previous scan, allows a two-dimensional scan (φ×θ) to be performed.

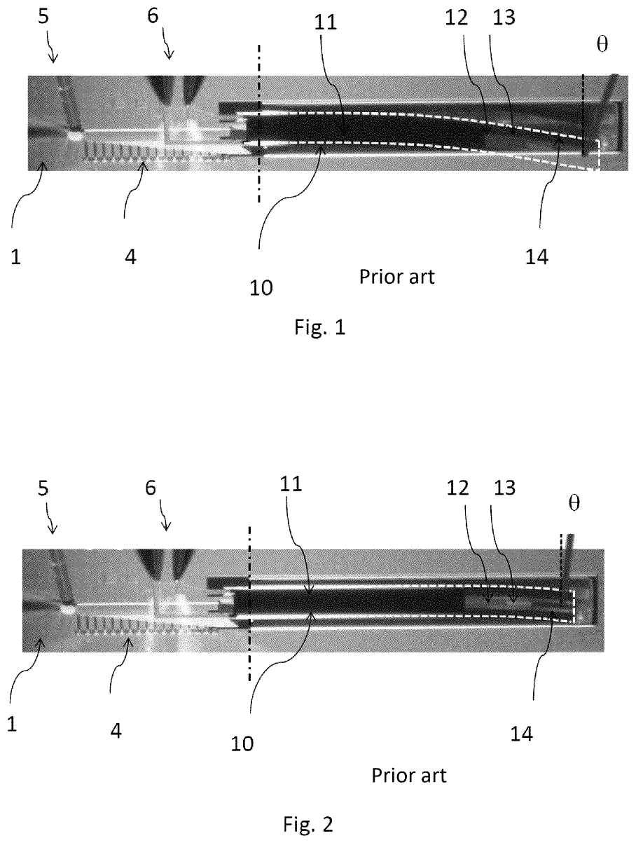

The principles presented with reference to FIGS. 1 and 2 are also employed, potentially with some modification, in this embodiment.

Integration of a position sensor allows the direction of the beam emitted at the angle θ to be tracked in real time.

Into the lidar comprising the microbeam 100, and on the latter the optical phased array 120, a position sensor 150 is integrated on the microbeam 100, the position sensor for example being a piezoelectric gauge, or for example an optical gauge, and making it possible to directly track the position of the microbeam 100 in respect of the angle θ, and therefore the direction of the beam emitted by the lidar at θ.

A controller 190 takes this position information into account, and uses it when modulating a command transmitted to the piezoelectric actuator or a command transmitted to the light source applied to the optical input 110, this providing guarantees in terms of safety and reliability.

The position of the beam in respect of φ is moreover tracked within the photonic circuit.

Another embodiment will now be presented. It uses an optical gauge, manufactured using a Mach-Zehnder interferometer (MZI).

In FIG. 4, the principle of the Mach-Zehnder interferometer is recalled. A Mach-Zehnder interferometer uses, on a waveguide fed by an optical input 60, a splitter 61 that distributes the injected light between two independent arms: the reference arm 62 and the sensor arm 64, which includes a specific path 65. The light beams routed to the two arms are then mixed via a combiner 68 to produce a single output beam that is exploited at the optical output 69. In the case of coherent light, the transmittance of the MZI depends on the phase difference between the two arms. Thus, the transmittance of an MZI varies sinusoidally as a function of the wavelength of the light applied as input with maxima corresponding to constructive interference (signals of the two arms in phase) and minima to destructive interference (signals of the two arms in anti-phase). An MZI therefore makes it possible to translate a phase variation Δφ into an intensity variation ΔI, which is simpler to detect.

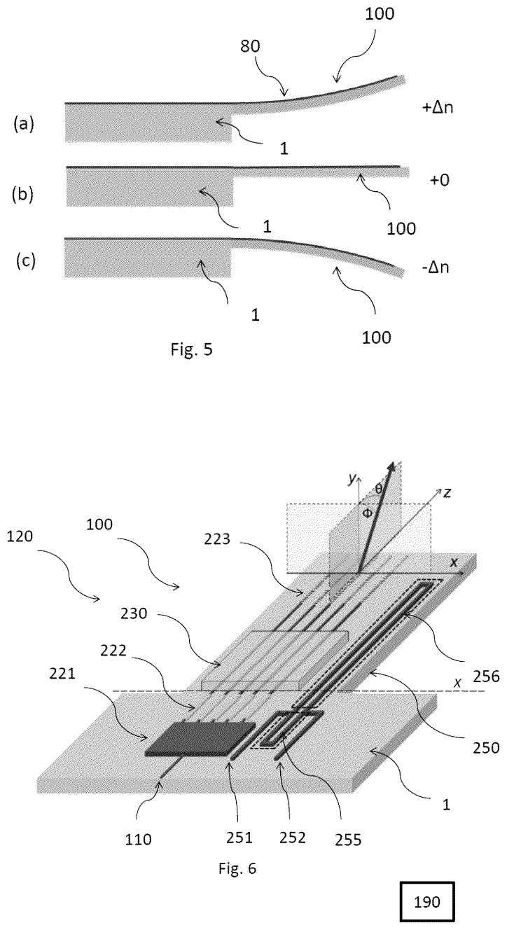

As illustrated in FIG. 5, the refractive indices of certain solid materials, and this is the case for silicon, depend on the stress to which the material is subjected, due to the so-called photoelastic effect. Thus, the phase of light propagating through a waveguide undergoing a stress is modified. The photoelastic effect is of the order of Δn=10⁻⁶ for a stress of 40 MPa, which may be applied with a PZT actuator as described in the article by Tang et al., Hybrid integrated ultralow-linewidth and fast-chirped laser for FMCW LiDAR, Opt. Express, vol. 30, no. 17, p. 30420, 2022.

Thus the figure, which is a side view, shows the carrier 1 and the microbeam 100, the microbeam bearing a silicon waveguide 80 on its top side and being bent upward at (a), this compressing the silicon of the waveguide 80 and modifying its refractive index by +Δn, unbent at (b), and bent downward at (c) by an amount equivalent to the amount it is bent upward at (a), this stretching the silicon of the waveguide 80 and modifying its refractive index by −Δn.

FIG. 6 It is proposed to use the principle of the Mach-Zehnder interferometer (MZI) to produce an optical position sensor or gauge, one of the arms of the MZI serving as a zone exposed to strain, which varies over time, and the other serving as a fixed reference and for example remaining unstressed.

FIG. 6 again shows a carrier 1, a microbeam 100 of direction z, bending about the direction X, an optical input 110 on the carrier 1 in proximity to the microbeam and an optical phased array 120 placed between the optical input 110 and the free end of the microbeam. The optical phased array comprises: a beam splitter 221 that splits light delivered by the optical input 110 into N beams that are guided into parallel waveguides that are arranged side by side on the carrier 1 and then onto the microbeam 100; phase modulators 222, in an amount of one modulator for each of the waveguides (the means for controlling the modulators has not been shown); and, placed at the end of the microbeam 100, antennas 223 for emitting the light guided by the various parallel waveguides, the active parts of the antennas 223 forming a rectilinear row on the distal part of the microbeam 100. Phase modulation allows the light beam to be oriented at the angle φ around the direction y (in the xy-plane).

The principles presented with reference to FIGS. 1 and 2 are once again also employed, potentially with some modification, in this embodiment.

In addition, an MZI 250 is provided, which MZI comprises an optical input 251 and an optical output 252 on the carrier 1, the reference arm 255 of the MZI, which is located off the microbeam, also being on the carrier 1, the sensor arm 256 of the MZI being placed, in whole or in part, on the microbeam 100. For this purpose, the sensor arm 256 is for example composed essentially of two rectilinear segments that lie parallel to each other, and of an elbow forming a half-turn connecting the two segments. The two segments are placed parallel to the waveguides, over a significant length of the microbeam, the bend optimally being in line with the antennas 223, so that the two segments of the sensor arm 256 travel the entire length of the microbeam.

The microbeam 100 is equipped with a piezoelectric actuator 230, which is controlled by a voltage that is applied to it (the terminals have not been shown in the figure), this causing variations in the extent to which the microbeam is bent and therefore allowing the light beam to be oriented about the direction x (in the yz-plane), at the angle θ.

When the microbeam 100 is actuated by the actuator 230, a stress is created within the sensor arm 256, and this stress creates a difference in the refractive index of the waveguide over a length that is all the greater given that the sensor arm 256 is installed over the entire length of the microbeam 100, right up to near its free end. In contrast, the reference arm 255 is not subjected to any stress. Measuring the light intensity at the output of the MZI then makes it possible to determine the current position of the microbeam 100, using the principle explained with reference to FIG. 4. The optical output 252 reads this intensity with a photodiode for example.

Once again, a controller 190 takes the position information into account, and uses it when modulating a command transmitted to the piezoelectric actuator or a command transmitted to the light source applied to the optical input 110, this providing guarantees in terms of safety and reliability.

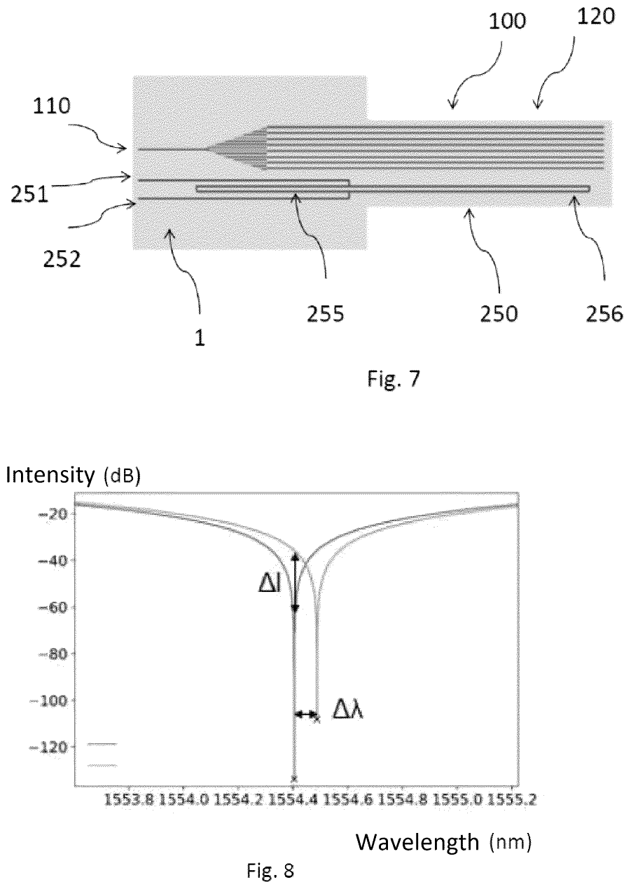

FIG. 7A top view of the system of FIG. 6 is shown in FIG. 7, with integration of the position sensor into a microbeam on which has been placed, previously or in parallel, an OPA photonic circuit comprising a splitter, modulators and antennas. Once again the microbeam has an actuator, which in this embodiment is a PZT actuator. The optical position sensor is placed with one of the arms of the MZI on the microbeam—this is the sensor arm—and the second off the microbeam—this is the reference arm. The reference arm may also consist of two segments that lie parallel to each other and that are connected to each other by a bend forming a half-turn. It is proposed that the length of the sensor arm be greater than the length of the reference arm.

An MZI with the following characteristics is considered:
length of the reference arm L_{ref}=8 mm, difference in length between the two arms ΔL=50 μm, hence the relationship Lₛₑₙₛ=L_{ref}+ΔL,
refractive indices at rest in the waveguides of the reference arm and of the sensor arm equal n_{ref}=nₛₑₙₛ=3. The sensor arm in addition undergoes a maximum modification (addition or subtraction) of the refractive index Δn.
   In addition, wave vectors in the sensor arm and in the reference arm are introduced:

$${β}_{ref} = \frac{2 π {n}_{ref}}{λ} and {β}_{sens} = \frac{2 π ( {n}_{sens} + Δ n )}{λ} .$$

An analytical simulation may be performed using the equation describing the output intensity of an MZI:

$${I}_{0} = \frac{1}{2} [ 1 + cos ( {β}_{ref} {L}_{ref} - {β}_{sens} {L}_{sens} ) ]$$

The light intensity I₀ at the output of the MZI is therefore wavelength-dependent.

FIG. 8 As may be seen in FIG. 8, the destructive interference peak at the output of the MZI shifts in wavelength by a value Δλ when a stress is applied by the PZT actuator (PZT actuator active Δn=10⁻⁶) compared to the unstressed state (PZT actuator inactive Δn=0). By adjusting the wavelength of the laser to place it close to a peak interference value of the MZI, it is therefore possible to obtain a detectable intensity variation ΔI₀, depending on the position of the microbeam, and therefore allow said position to be determined.

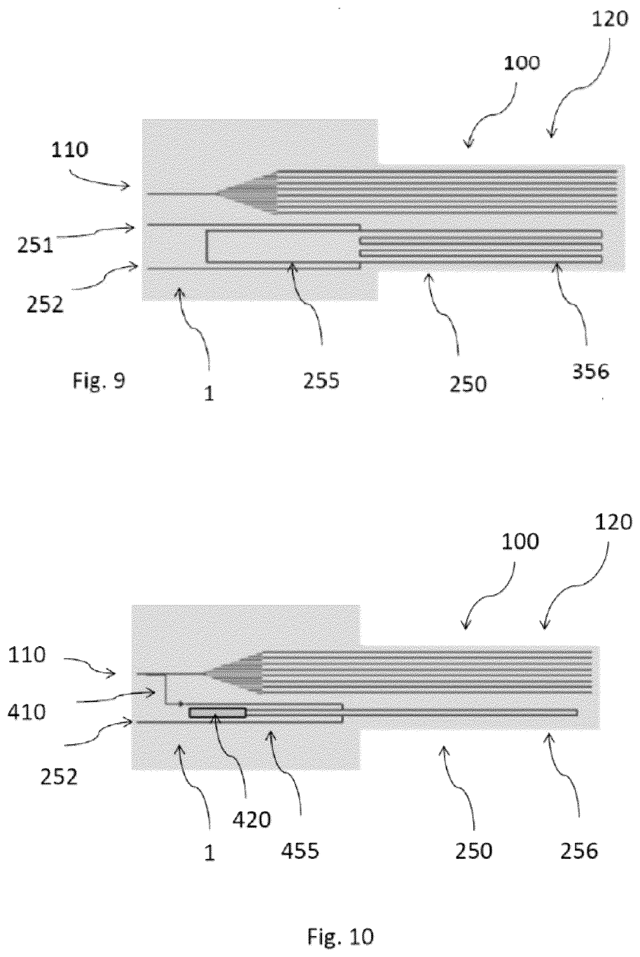

FIG. 9A variant will now be presented with reference to FIG. 9.

FIG. 9 again shows a carrier 1, a bending microbeam 100, an optical input 110 on the carrier 1 in proximity to the microbeam and an optical phased array 120 placed between the optical input 110 and the free end of the microbeam.

In addition, an MZI 250 is provided, which MZI comprises an optical input 251 and an optical output 252 on the carrier 1, the reference arm 255 of the MZI, which is located off the microbeam, also being on the carrier 1, the sensor arm 356 of the MZI being placed, in whole or in part, on the microbeam 100. The sensor arm 356 is composed of a plurality of segments in series making a plurality of outward and return trips over the microbeam, in order to increase the length of the sensor arm and therefore the sensitivity of the gauge. Going back and forth a number of times in this way allows a greater phase delay to be accumulated in the sensor arm with respect to the reference arm. This solution, which increases sensitivity, requires the footprint of the waveguide forming the sensor arm to be greater, this potentially being facilitated by increasing the width of the microbeam with respect to the embodiment of FIG. 7.

FIG. 10A variant shown in FIG. 10 has a phase modulator integrated into the reference arm, this allowing the wavelength of interference peaks of the interferometer to be modified.

FIG. 10 again shows a carrier 1, a bending microbeam 100, an optical input 110 on the carrier 1 in proximity to the microbeam and an optical phased array 120 placed between the optical input 110 and the free end of the microbeam. In addition, an MZI 250 is provided, which MZI comprises an optical output 252 on the carrier 1, the sensor arm 256 of the MZI being placed, in whole or in part, on the microbeam 100.

However, the reference arm 455, which is placed as before on the carrier 1, outside of the stressed zone, comprises an electrically controlled phase modulator 420 which allows the point of maximum interference of the Mach-Zehnder interferometer to be found, and thereby the amplitude of the signal to be increased without having to modify the wavelength of the laser, and therefore the sensitivity of the device to be increased easily.

In addition, this variant uses sampling of the laser source 110 used for the optical phased array OPA to feed the interferometer MZI, through application of a two-channel beam splitter 410. The optical input of the interferometer is therefore coupled to the second channel of the beam splitter 410, the optical phased array 120 being coupled to the first channel of the beam splitter 410. This avoids the need to use a specific laser for the MZI, since a laser is used for the optical phased array (OPA).

The presented micromechanical optical-sensor structure is used to scan a scene or an environment, by a stationary or moving object, and typically in the context of a lidar, for example a lidar implemented in a motor vehicle in order to prevent collisions with pedestrians or vehicles.

1. A micromechanical optical-sensor structure comprising a microbeam that is able to bend about a first direction (x), an actuator controlled to modify the orientation of the microbeam about said first direction (x) and, at a free end of said microbeam, antennas of an optical phased array, said antennas being arranged to emit a light beam that is orientable about a second direction (y) transverse to the first direction (x), wherein the micromechanical structure in addition comprises an on-board sensor in the microbeam transmitting a signal representative of a current orientation of the microbeam about the first direction (x).

2. The micromechanical optical-sensor structure according to claim 1, wherein the on-board sensor comprises a waveguide comprising a material the refractive index of which depends on a mechanical stress of said material, which varies with the orientation of the microbeam about said first direction (x).

3. The micromechanical optical-sensor structure according to claim 1, wherein the micromechanical structure comprises a Mach-Zender interferometer, said on-board sensor comprising a sensor arm of said Mach-Zender interferometer.

4. The micromechanical optical-sensor structure according to claim 1, wherein the microelectronic structure comprises a beam splitter for transmitting light generated by a given source to the antennas of the optical phased array and to the on-board sensor, which is an optical sensor.

5. The micromechanical optical-sensor structure according to claim 1, wherein the microelectronic structure comprises a controlled phase modulator for modifying an amplitude of an interference signal exploited by said on-board sensor.

6. The micromechanical optical-sensor structure according to claim 1, wherein the on-board sensor comprises a waveguide making at least one outward and return trip along the microbeam.

7. A lidar device comprising a micromechanical optical-sensor structure according to claim 1, a coherent light source for emitting via the antennas of the optical phased array and a controller for controlling the actuator and the optical phased array so as to orient in two dimensions (φ, θ) an emitted lidar beam.

8. A motor vehicle comprising a lidar device according to claim 7 for detecting obstacles to the movement of the vehicle.
